(19) United States
(12) Patent Application Publication
(10) Pub. No.: US 2025/0072450 A1
(43) Pub. Date: Mar. 6, 2025

(54) Method for preparing ice cream with good storage and transportation stability

(71) Applicant: China Agricultural University, Beijing (CN)

(72) Inventors: Xingyun Peng, Beijing (CN); Wenfeng Xie, Beijing (CN); Guoyin Zhu, Beijing (CN); Zhimin Li, Beijing (CN)

(21) Appl. No.: 18/676,516

(22) Filed: May 29, 2024

(30) Foreign Application Priority Data
Sep. 5, 2023 (CN) 202311137530.6

(51) Int. Cl. A23G 9/22; A23G 9/32; A23G 9/34

(52) U.S. Cl. CPC A23G 9/22; A23G 9/327; A23G 9/34

(57) ABSTRACT

The present invention discloses a method for preparing ice cream with good storage and transportation stability. The raw materials of the ice cream include small-granule starch. The amount of small-granule starch added is 1% to 6%. By adding small-granule starch to the ice cream, the structure of the ice cream is improved, resulting in ice cream with good storage and transportation stability. It can maintain ideal hardness at high storage and transportation temperatures while retaining good shape, texture, and sensory qualities. This enhances the ice cream product's resistance to temperature fluctuations during cold chain storage and transportation, making it suitable for storage and sales temperatures higher than conventional storage temperatures (−18° C.), thus promoting energy saving and carbon reduction in the ice cream storage and transportation process.

### TECHNICAL FIELD

The present invention relates to the field of food processing technology, specifically to a method for preparing ice cream with good storage and transportation stability.

### BACKGROUND

Ice cream is a common frozen food, but its high dependence on low-temperature cold chains consumes a significant amount of energy during the cold chain process, with carbon emissions accounting for approximately 50% of the total carbon emissions in the product's lifecycle. The main energy-consuming activities during the ice cream cold chain process are the long-distance transportation of refrigerated trucks and the storage of ice cream in various cold storage facilities, with electricity required for refrigeration being the main source of energy consumption. Therefore, reducing the dependence of ice cream on low-temperature cold chains to withstand higher temperature transportation and storage can reduce the operating time of refrigeration compressors, thereby significantly reducing energy consumption and carbon footprint.

Due to the extreme sensitivity of ice cream to temperature, higher constant storage temperatures and temperature fluctuations during storage and transportation can cause changes in the microstructure and physical properties of ice cream. Currently, the storage and transportation temperature of ice cream is not higher than −18° C. Under higher storage temperatures and temperature fluctuations in the cold chain, ice crystal growth or recrystallization is prone to occur, resulting in larger ice crystals, which affect the mouthfeel of ice cream. Additionally, at higher storage temperatures, ice crystals partially melt, increasing the moisture content of the ice cream and softening its texture. Maintaining the texture and sensory quality of ice cream and improving its stability at higher storage temperatures without affecting its mouthfeel are key technological issues to ensure the feasibility of reducing carbon emissions in the ice cream cold chain.

Small-particle starch refers to a type of starch with particle diameters smaller than 10 μm. Small-particle starch has characteristics such as small particle size, uniform size distribution, and good freeze-thaw stability, making it play a special role in the production of biodegradable materials, fat substitutes, carrier materials, and cosmetics. However, the role of small-particle starch in improving the stability of ice cream at higher storage temperatures without affecting its taste has not been disclosed.

### SUMMARY

The present invention addresses the issues of poor shape retention, low hardness, and inferior sensory quality of ice cream at high storage and transportation temperatures by providing an ice cream with good storage and transportation stability and its preparation method. The addition of small-particle starch is employed to improve the structure of ice cream (which can be either reduced sugar or regular ice cream), enabling it to maintain its appearance and ideal sensory and textural qualities at higher storage and transportation temperatures, thereby enhancing its resistance to temperature fluctuations in the cold chain and facilitating energy-saving and carbon reduction in the ice cream transportation process.

To achieve the above objectives, the technical solution of the present invention is as follows:

The present invention provides ice cream with good storage and transportation stability, which can maintain ideal hardness and good appearance, texture, and sensory quality at high storage and transportation temperatures, demonstrating excellent stability during storage and sales processes.

Preferably, the ice cream mentioned above is suitable for storage and sales temperatures higher than the conventional storage temperature (−18° C.), specifically up to −5° C.

Preferably, the ice cream mentioned above includes but is not limited to soft serve and hard serve ice cream.

Preferably, the ice cream mentioned above can be either reduced sugar or regular ice cream, where “sugar” refers to simple sugars (soluble sugars), including but not limited to sucrose, glucose, fructose, and syrups; “reduced sugar ice cream” refers to ice cream made using any replacements of the simple sugars.

The raw materials of the ice cream mentioned above include small-particle starch.

The small-particle starch mentioned above includes natural small-particle starch and/or modified small-particle starch.

Preferably, the small-particle starch mentioned above includes but is not limited to natural small-particle starch such as rice starch, sweet corn starch, grain amaranth starch, taro starch, cow cockle starch, and quinoa starch; small-particle starch processed from granular or large particle starch such as corn starch, cassava starch, and potato starch through physical, chemical, and biological methods; and modified starch obtained from small-particle starch as the raw material through physical, chemical, and biological modification methods, including but not limiting to cross-linking, etherification, and esterification modification.

Based on the total mass of ice cream raw materials, the addition amount of small-particle starch mentioned above ranges from 1% to 6%.

During the ice cream production process, the swelling power of the small-particle starch in the ice cream mixture does not exceed 3.

The present invention also provides a preparation method for the aforementioned ice cream with good storage and transportation stability. The preparation method comprises the following steps:
(1) Prepare homogenized ice cream slurry according to conventional ice cream preparation methods, cool it to below 50° C., add natural and/or modified small-particle starch slurry, stir to obtain a mixed slurry.
(2) After incubating and stirring the mixed slurry at 4° C. for 12 to 18 hours, freeze it, and optionally conduct low-temperature hardening to obtain the ice cream product.

Specifically, in step (1) of the above method, the mass ratio of natural and/or modified small-particle starch to water in the natural and/or modified small-particle starch slurry ranges from 1:1.5 to 1:3;

The operation in step (1) is as follows:
(1.1) Weigh the materials according to the formula, mix the dry powder materials excluding the small-particle starch, add water while stirring, then add oil and continue stirring;
(1.2) After the materials are evenly mixed, subject them to high-speed shear while stirring;
(1.3) Pasteurize the sheared ice cream slurry;
(1.4) Cool the pasteurized ice cream slurry to 55-65° C., homogenize it, and obtain homogenized ice cream slurry;

In step (1.1), the water temperature ranges from 60° C. to 70° C., specifically 65° C. or 70° C. water; In step (1.2), high-speed shear is performed at a temperature of 60-70° C. (specifically 65° C.); The stirring rate is 300-2000 rpm, specifically 1200 rpm; The high-speed shear rate is 5000-20000 rpm, specifically 10000 rpm; In step (1.3), pasteurization is carried out at 80-85° C. for 20-60 seconds, specifically 82° C. for 25 seconds; In step (1.4), homogenization is performed under conditions of 15-18 MPa.

In step (2), the freezing time can be 10-15 minutes.

The small-particle starch can be modified small-particle starch, and it can also be added during the mixing of dry powder materials (i.e., step 1.1), followed by steps (1.2)-(1.4), and then the operation of step (2) to obtain ice cream containing modified small-particle starch.

The application of small-particle starch in ice cream preparation is also within the scope of the present invention.

The application is to add small-particle starch to ice cream with or without reduced soluble sugar, improve the hardness and structure of ice cream, obtain finer ice crystals and smoother structure, enhance the resistance of ice cream products to temperature fluctuations in the cold chain, making ice cream suitable for storage and sales temperatures higher than the conventional storage temperature (−18° C.).

The present invention offers the following beneficial effects:

By adding small-particle starch to ice cream to improve its structure, the invention yields ice cream with good storage and transportation stability. This ice cream maintains ideal hardness, appearance, texture, and sensory quality even at higher transportation temperatures. It enhances the ice cream product's resilience to temperature fluctuations during cold chain transportation, making it suitable for storage and sales temperatures higher than the conventional (−18° C.), thereby promoting energy-efficient and low-carbon storage processes for ice cream.

Additionally, incorporating small-particle starch into ice cream with or without reduced soluble sugar enhances its hardness at higher transportation temperatures, resulting in finer ice crystals and a smoother structure. Compared to commonly used medium or large particle starches like corn starch and potato starch, small-particle starch has a smaller average diameter of less than 10 μm. Its addition to ice cream does not create a noticeable foreign texture, ensuring sensory quality while improving hardness and stability at higher transportation temperatures. This enhancement strengthens the ice cream's resilience to temperature fluctuations during cold chain transportation, promoting energy-efficient and low-carbon storage practices, and driving the green and low-carbon development of frozen food.

### BRIEF DESCRIPTION OF DRAWINGS

FIG. 1 illustrates the melting characteristics of ice cream prepared in Embodiment 1 (A), Comparative Embodiment 1 (B) and Comparative Embodiment 2 (C) of the present invention.

FIG. 2 illustrates a frozen scanning electron microscope observation picture of the ice cream prepared in Embodiment 1 (left), Comparative Embodiment 1 (middle) and Comparative Embodiment 2 (right) of the present invention.

### DETAILED DESCRIPTION OF EMBODIMENTS

The present invention will be described in further detail below in conjunction with specific embodiments. The Embodiments given are only for illustrating the present invention and are not intended to limit the scope of the present invention. The Embodiments provided below can serve as a guide for those of ordinary skill in the art to make further improvements, and do not constitute a limitation of the present invention in any way.

The experimental methods in the following Embodiments, unless otherwise specified, are all conventional methods and are carried out in accordance with the techniques or conditions described in literature in the field or in accordance with product instructions. Materials, reagents, etc. used in the following Embodiments can all be obtained from commercial sources unless otherwise specified.

### Comparison 1

This comparison provides a reduced-sugar ice cream without added small-granule starch. The raw material formula is as follows: Coconut oil 8.0%, whole milk powder 8.0%, soy protein isolate 3.0%, fructose 3.0%, maltodextrin 10.3%, monk fruit glycosides 0.04%, carrageenan 0.02%, guar gum 0.1%, locust bean gum 0.15%, mono and diglycerides 0.2%, vanilla flavor essence 0.2%, with the remainder supplemented with water to 100%. The percentages are mass percentages of the total mass of the ingredients. The preparation method includes the following steps: (1) Accurately weigh each ingredient according to the formula. Mix and stir all dry powder ingredients except for the essence, then slowly add to 65° C. water while stirring, followed by adding coconut oil and stirring thoroughly. (2) After the materials are evenly mixed, perform high-speed shearing at 65° C. while stirring to ensure uniform dispersion, with a shearing rate of 10000 rpm and stirring rate of 1200 rpm. (3) Pasteurize the sheared ice cream mixture at 82° C. for 25 s. (4) Homogenize the pasteurized ice cream mixture under 16 MPa pressure after cooling to 60° C. (5) Age the mixed slurry at 4° C. for 12 hours. (6) Add vanilla flavor essence to the aged slurry and mix evenly. (7) Freeze the aged ice cream slurry in a small hard ice cream machine for 10minutes to make ice cream, with a swelling rate of 46%. (8) Pack the frozen ice cream into ice cream cups, cover with lids, and place in a −40° C. freezer for 4 hours for hardening before storing in the freezer.

### Comparison 2

This comparison provides a regular ice cream without added small-granule starch (non-reduced-sugar ice cream). The raw material formula is as follows: Coconut oil 8.0%, whole milk powder 8.0%, soy protein isolate 3.0%, sucrose 13.3%, carrageenan 0.02%, guar gum 0.15%, locust bean gum 0.2%, mono and diglycerides 0.2%, vanilla flavor essence 0.2%, with the remainder supplemented with water to 100%. The percentages are mass percentages of the total mass of the ingredients. The preparation method is the same as Comparison 1.

### Embodiment 1

This Embodiment provides an ice cream with good storage stability. The raw material formula is as follows: Coconut oil 8.0%, whole milk powder 8.0%, soy protein isolate 3.0%, fructose 3.0%, maltodextrin 8.3%, small-granule starch (seed amaranth starch) 2.0%, monk fruit glycosides 0.04%, carrageenan 0.02%, guar gum 0.10%, locust bean gum 0.15%, mono and diglycerides 0.2%, vanilla flavor essence 0.2%, with the remainder supplemented with water to 100%. The percentages are mass percentages of the total mass of the ingredients. The preparation method is the same as Comparison 1, with the addition of seed amaranth starch during the cooling step and aging for 12 hours before freezing.

The resulting ice cream maintains ideal hardness and retains good appearance, texture, and sensory quality under high storage and transportation temperatures. Compared to the reduced-sugar ice cream without added small-granule starch in Comparison 1, the reduced-sugar ice cream with 2% seed amaranth starch exhibits approximately a 50% increase in hardness at −5° C. Its resistance to melting is significantly improved, evidenced by delayed initial dripping time when placed on a wire mesh at 25° C. Compared to the non-reduced-sugar regular ice cream in Comparison 2, the reduced-sugar ice cream with 2% seed amaranth starch shows over a tenfold increase in hardness at −5° C. and over 100% delayed initial dripping time when placed on a wire mesh at 25° C. The resulting ice cream maintains its stability while enhancing sensory quality. Sensory evaluations indicate that the reduced-sugar ice cream with 2% seed amaranth starch has no difference in foreign body sensation compared to Comparison 1 (foreign body sensation score of 1), and there are no foreign body sensations detected in the product. Compared to the reduced-sugar ice cream without added small-granule starch in Comparison 1, the reduced-sugar ice cream with 2% seed amaranth starch exhibits a finer matrix network pore size in frozen scanning electron microscope images, indicating finer ice crystals and a more delicate structure. Therefore, adding seed amaranth starch to ice cream improves hardness, enhances the structure, and increases the ice cream's tolerance to temperature fluctuations during cold chain storage and transportation, making it suitable for storage and sale temperatures higher than the conventional (−18° C.).

### Embodiment 2

This Embodiment provides ice cream with good storage stability. The raw material formula is similar to Embodiment 1 but with 4% seed amaranth starch. The preparation method is identical to Embodiment 1. The resulting ice cream exhibits ideal hardness under high storage and transportation temperatures, maintaining good appearance, texture, and sensory quality. Compared to the reduced-sugar ice cream without added small-granule starch in Comparison 1, the reduced-sugar ice cream with 4% seed amaranth starch exhibits over a doubling of hardness at −5° C. Its resistance to melting is significantly improved, with over 100% delayed initial dripping time when placed on a wire mesh at 25° C. Compared to the non-reduced-sugar regular ice cream in Comparison 2, the reduced-sugar ice cream with 4% seed amaranth starch exhibits over twenty times increased hardness at −5° C. and over 200% delayed initial dripping time when placed on a wire mesh at 25° C. The resulting ice cream maintains its stability while retaining good sensory quality. Sensory evaluations indicate no difference in foreign body sensation compared to Comparison 1, with a score of 1 indicating no foreign body sensation, and the texture is described as smooth and creamy.

### Embodiment 3

This Embodiment provides a kind of ice cream with good storage and transportation stability, and its raw material formula is as follows: Coconut oil 8.0%, whole milk powder 8.0%, soy protein isolate 3.0%, fructose 3.0%, maltodextrin 8.3%, rice starch (small-particle starch, particle size 3-8 μm) 2.0%, monk fruit glycosides 0.04%, carrageenan 0.02%, guar gum 0.1%, locust bean gum 0.15%, mono-and diglycerides 0.2%, vanilla flavor essence 0.2%, with the remainder supplemented with water to 100%, where the percentages are mass percentages of the total mass of the raw materials. The preparation method is the same as in Embodiment 1. The obtained ice cream has ideal hardness at high storage and transportation temperatures and maintains good appearance, texture, and sensory quality. Compared with Embodiment 1, the sugar-reduced ice cream without adding small-particle starch, the hardness of the sugar-reduced ice cream with 2% rice starch added increased by more than 50% at −5° C. The melt resistance of the ice cream is significantly improved, and the initial drip time of the ice cream placed on a wire mesh at 25° C. is delayed by 30%. Compared with Embodiment Example 2, the normal ice cream without sugar reduction, the hardness of the sugar-reduced ice cream with 2% rice starch added increased by 16 times at −5° C. The melt resistance of the ice cream is significantly improved, and the initial drip time of the ice cream placed on a wire mesh at 25° C. is delayed by more than 100%. While the stability of the obtained ice cream is improved, good sensory quality is maintained. Sensory evaluation results show that the sugar-reduced ice cream with 2% rice starch added is not different from Embodiment 1 in terms of foreign body sensation (foreign body sensation score is 1), with a fine and smooth texture.

Measurement of Small-particle Starch Swelling: Using small-particle starch as the raw material, the mass of the centrifuge tube is measured and denoted as m₁. Prepare a 20 g 1% (w/w) starch slurry in the centrifuge tube, accurately weigh the starch mass on a one-thousandth balance and denote it as m₂, and add the corresponding mass of distilled water. Place the centrifuge tube in a boiling water bath and heat for 30 minutes to gelatinize. Shake the centrifuge tube 10 times every minute for the first 5 minutes of heating, then shake it 10 times every 5 minutes to ensure uniform sample gelatinization. Cool the centrifuge tube to room temperature, centrifuge at 10,000 rpm at 6° C. for 30 minutes. Weigh the mass of an aluminum foil weighing dish and denote it as m₃. Pour the supernatant after centrifugation into the weighing dish and dry it in a hot air oven at 130° C. until constant weight (about 4 hours). After removing the weighing dish, quickly place it in a desiccator, cool it to room temperature, and weigh it, denoted as m₄. The total mass of the centrifuge tube and the precipitate after removing the supernatant is denoted as m₅. The swelling ratio of starch in the raw state is determined without gelatinization steps. The calculation formula for swelling ratio is as follows:

$$Swelling rate ( \% ) = ( mass of ice cream slurry - mass of ice cream ) / mass of ice cream \times 100 \%$$

The swelling ratio of natural small-particle starch used in the present invention in the raw state is 3.0. The performance indicators of ice cream in the present invention are measured by the following methods:

Swelling rate: The swelling rate is an important indicator reflecting the gas content of ice cream, which can affect the texture, melt resistance, sensory characteristics, and other qualities of ice cream. The swelling rates of ice cream slurries before and after freezing are determined for implementation and comparative Embodiments. Measure the mass of ice cream slurry before freezing and the finished ice cream after freezing using a 50 mL graduated cylinder, level the surface with a stainless steel spatula, and weigh according to the following formula to calculate the swelling rate of ice cream:

$$Swelling ratio ( g / g ) = ( {m}_{5} - {m}_{1} ) / [ {m}_{2} - ( {m}_{4} - {m}_{3} ) ]$$

Hardness: The hardness of ice cream stored in a −5° C. freezer for 48 hours is measured using a texture analyzer. The sample has a diameter of 54 mm and a height of 38 mm. The ice cream is immediately tested at 16° C. after removal from the freezer, using a TA41 probe (6 mm stainless steel cylindrical flat-bottom probe) in compression mode. Test conditions are as follows: trigger force load 5 g, pre-test and post-test speed 1 mm/s, test speed 3 mm/s, test depth 25 mm, and record hardness. To ensure the stability of test results, all sample probes are pre-cooled to 0° C. before testing. The results are shown in Table 1. Adding rice starch granules can increase the hardness of ice cream, increasing the hardness of ice cream by 41% to 119%.

The comparison table between this embodiment and the comparative Embodiment is as follows:

TABLE 1
Comparison table

| Project | Embodiment 1 | Embodiment 2 | Embodiment 3 | Comparison 1 | Comparison 2 |
|---|---|---|---|---|---|
| small-granule starch | 2% grain amaranth | 4% grain amaranth | 2% rice starch | None | None |
| | starch | starch | | | |
| Hardness at −5° C. | 314 | 488 | 338 | 223 | 20 |
| (kPa) | | | | | |
| Initial dripping time | 65 | 110 | 65 | 50 | 30 |
| of ice cream (min) | | | | | |

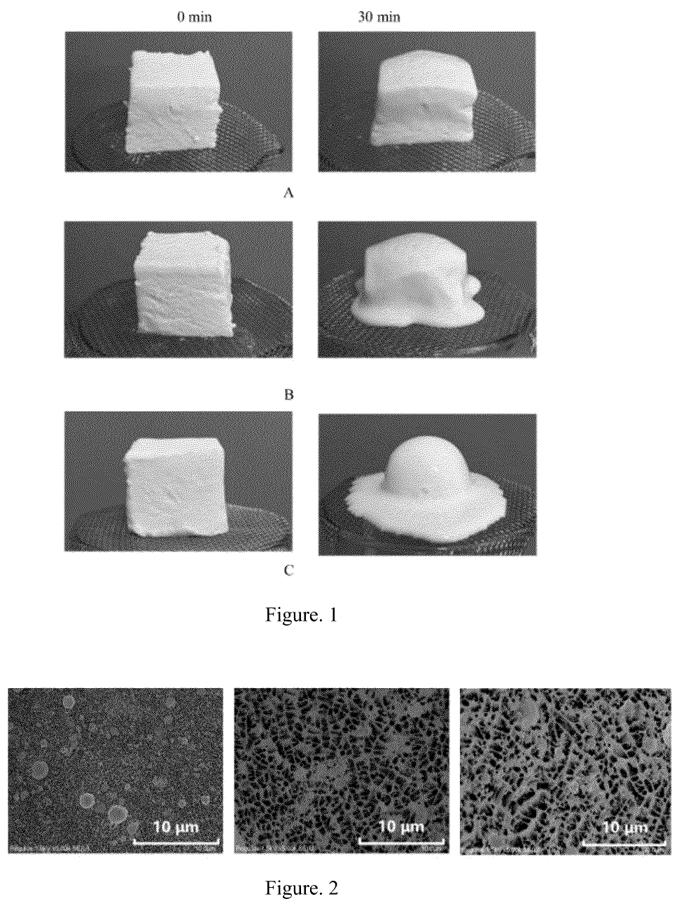

Melting Characteristics: The melting characteristics of ice cream at 25° C. are determined. Samples of Embodiments 1, 2, 3, and Comparative Embodiment 1 are ice creams stored in a −5° C. freezer for 48 hours, while samples of Comparative Embodiment 2 are ice creams stored in a −12° C. freezer for 48 hours. Take 20.0 g of ice cream and place it on a metal mesh (aperture 1.4 mm) in a constant temperature incubator at 25±1° C., with a beaker placed under the metal mesh to collect the melted ice cream drops. Record the mass of dripping ice cream every 5 minutes and time for 2 hours. Record the initial dripping time of ice cream. FIG. 1 shows the melting characteristics of ice creams prepared in Embodiment 1 (A), Comparative Embodiment 1 (B), and Comparative Embodiment 2 (C).

Sensory Evaluation Method: Analytical sensory evaluation is used to evaluate the foreign body sensation of ice creams prepared in Embodiments 1, 2, 3, and Comparative Embodiment 1. Samples are stored in a −5° C. freezer for 48 hours before testing. The sensory evaluation panel consists of 6 researchers engaged in food research (3 males, 3 females). Samples are randomly numbered with digits, and sensory evaluation is conducted immediately after removing the ice cream from the freezer. Evaluators score the strength of foreign body sensation using a 5-point scale, with the following scoring criteria:

TABLE 2
Sensory evaluation criteria for foreign body sensation

| | No foreign | Almost no | Slightly | Almost | | |
|---|---|---|---|---|---|---|
| | body | foreign body | foreign body | Foreign body | Obvious | Strong foreign |
| Intensity | sensation | sensation | sensation | sensation | foreign body | body sensation |
| Scores | 0 | 1 | 2 | 3 | 4 | 5 |

Cryo-Scanning Electron Microscopy (Cryo-SEM): Cryo-SEM is used to observe the microstructure of ice creams prepared in Embodiment 1,Comparative Embodiment 1, and Comparative Embodiment 2. Samples are cut from the interior of cylindrical ice cream samples (approximately 100 mm\hat{ }3) using a pre-cooled surgical blade. The samples are immediately mounted on sample holders and immersed in liquid nitrogen (−196° C.). The sample holders and samples are transferred to a low-temperature preparation room under liquid nitrogen and fractured at −150° C. to expose the fresh surface of the ice cream. Sublimation is performed at −150° C. for 15 minutes. Then, a 30 nm gold coating is applied to the sample surface, and the microstructure of the cross-section is observed under a scanning electron microscope at a magnification of 5000×. The results are shown in FIG. 2.

What is claimed is:

1. An ice cream with good storage and transportation stability, characterized in that: the raw materials of the ice cream include small-granule starch; the small-granule starch comprises natural and/or modified small-granule starch.

2. The ice cream according to claim 1, characterized in that: the storage and sales temperature suitable for the ice cream is higher than the conventional storage temperature (−18° C.).

3. The ice cream according to claim 1, characterized in that: the ice cream includes soft serve ice cream and hard serve ice cream; the ice cream includes reduced-sugar ice cream and non-reduced-sugar ice cream.

4. The ice cream according to claim 1, characterized in that: based on the total mass of ice cream raw materials, the amount of small-granule starch added is 1% to 6%.

5. A method for preparing any one of the ice creams according to claims 1, comprising the following steps: (1) prepare homogenized ice cream slurry by conventional ice cream preparation method, cool to below 50° C., add natural and/or modified small-granule starch milk, stir to obtain a mixed slurry; (2) after incubating and stirring the mixed slurry at 4° C. for 12-18 hours, freeze it, and optionally perform low-temperature hardening to obtain the ice cream product.

6. The method according to claim 5, characterized in that: in step (1), the mass ratio range of natural and/or modified small-granule starch to water in the natural and/or modified small-granule starch milk is 1:1.5 to 1:3.

7. The method according to claim 5, characterized in that: the operation of step (1) comprises: (1.1) weigh the materials according to the formula, mix the dry powder materials except for the small-granule starch, add water while stirring, then add fat and stir; (1.2) after the materials are evenly mixed, perform high-speed shearing while stirring the materials; (1.3) Sterilize the sheared ice cream slurry; (1.4) cool the sterilized ice cream slurry to 55° C.-65° C., homogenize it to obtain homogenized ice cream slurry.

8. The method according to any one of claims 5, characterized in that:
the small-granule starch is modified small-granule starch, and can also be added during the mixing of dry powder materials.

9. An application of small-granule starch in ice cream preparation.

10. The application according to claim 9, characterized in that: the application is to add small-granule starch to soluble sugar-reduced or non-reduced ice cream to increase the hardness of ice cream, improve the structure of ice cream, make the ice crystals of the ice cream finer, the structure more delicate, and enhance the ice cream product's resistance to temperature fluctuations during cold chain storage and transportation, making the ice cream suitable for storage and sales temperatures higher than conventional storage temperatures.
